(19) United States
(12) Patent Application Publication
(10) Pub. No.: US 2019/0020699 A1
(43) Pub. Date: Jan. 17, 2019

(54) SYSTEMS AND METHODS FOR SHARING OF AUDIO, VIDEO AND OTHER MEDIA IN A COLLABORATIVE VIRTUAL ENVIRONMENT

(71) Applicant: Tsunami VR, Inc., Del Mar, CA (US)

(72) Inventors: David ROSS, San Diego, CA (US); Beth Ann BREWER, Escondido, CA (US)

(21) Appl. No.: 16/006,047

(22) Filed: Jun. 12, 2018

Related U.S. Application Data
(60) Provisional application No. 62/533,100, filed on Jul. 16, 2017.

(51) Int. Cl. H04L 29/06; G06F 3/01

(52) U.S. Cl. CPC H04L 65/4038; G06F 3/017

(57) ABSTRACT

Optimizing the sharing of media in a collaborative virtual environment. Particular methods and systems administer a virtual meeting in a virtual meeting space. The virtual meeting is conducted by a meeting coordinator and is attended by a plurality of attendees that operate different client devices, including virtual reality or augmented reality devices. An attendee request to present media during the virtual meeting is received from a client device operated by an attendee. A manual or automatic determination is made as to whether the attendee request should be granted such that the attendee is allowed to present the media during the virtual meeting. If a determination is made that the attendee request should be granted, the attendee is allowed to present the media during the virtual meeting.

### RELATED APPLICATIONS

This application relates to the following related application(s): U.S. Pat. Appl. No. 62/533,100, filed 2017 Jul. 7 16, entitled METHOD AND SYSTEM FOR OPTIMIZING THE SHARING OF AUDIO, VIDEO AND OTHER MEDIA IN A COLLABORATIVE VIRTUAL ENVIRONMENT. The content of each of the related application(s) is hereby incorporated by reference herein in its entirety.

### TECHNICAL FIELD

This disclosure relates to virtual reality (VR), augmented reality (AR), and mixed reality (MR) technologies.

### BACKGROUND

In collaborative environments human interactions are controlled by exercising manners and self control in order to create a productive environment. Participants interpret body language and facial expressions of others to determine when another participant is done talking, sharing or is ready to contribute to the meeting. When participants are located in the same room it is easy to rely on human behavior to control the interaction such that participants are not speaking over each other and causing friction. When participants are dispersed in different locations, such as when participants are connected via a virtual meeting, the ability to detect when a person is getting ready to contribute is diminished. There is a need for floor control (e.g., control who speaks) during a virtual meeting in a virtual environment.

### BRIEF DESCRIPTION OF THE DRAWINGS

FIG. 1A and FIG. 1B depict aspects of a system on which different embodiments are implemented for optimizing the sharing of media in a collaborative virtual environment.

FIG. 2 depicts a method for optimizing the sharing of media in a collaborative virtual environment.

FIG. 3 depicts a method for determining if an attendee request should be granted such that the attendee is allowed to present media during a virtual meeting.

FIG. 4A through FIG. 4C provide a communication sequence diagram for a system that automatically controls whether different attendees can present media.

FIG. 5A through FIG. 5B provide a communication sequence diagram for a system that manually controls whether different attendees can present media using decisions from a meeting coordinator.

### DETAILED DESCRIPTION

This disclosure relates to different approaches for optimizing the sharing of media in a collaborative virtual environment.

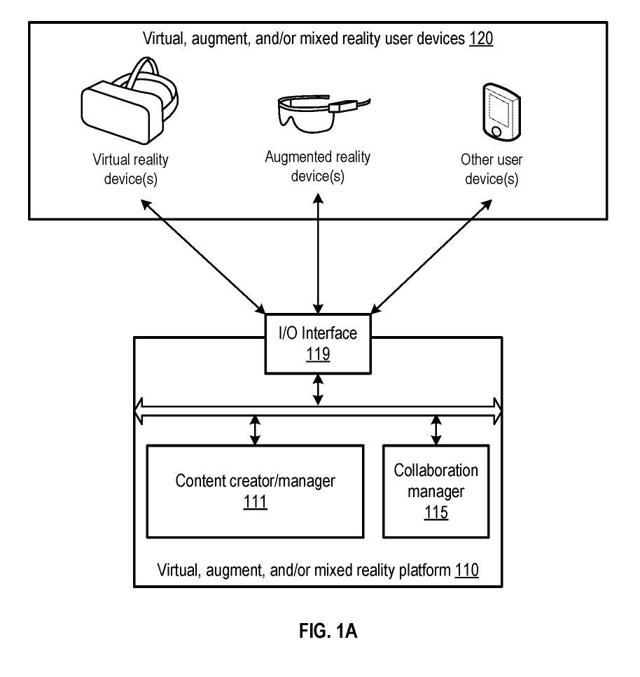

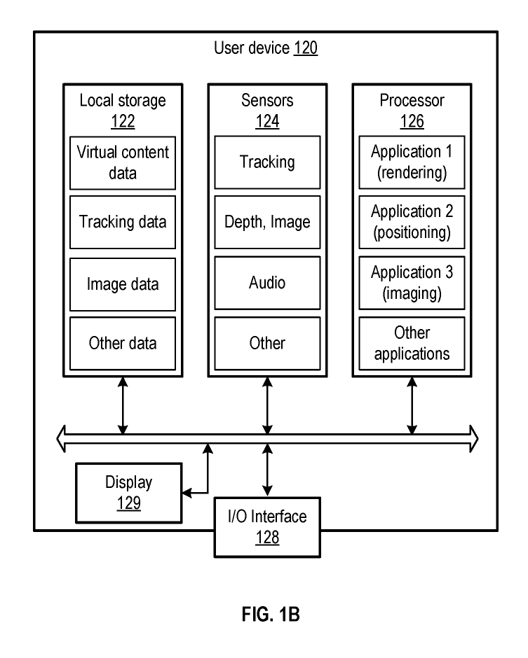

FIG. 1A and FIG. 1B depict aspects of a system on which different embodiments are implemented for optimizing the sharing of media in a collaborative virtual environment. The system includes a virtual, augmented, and/or mixed reality platform 110 (e.g., including one or more servers) that is communicatively coupled to any number of virtual, augmented, and/or mixed reality user devices 120 such that data can be transferred between the platform 110 and each of the user devices 120 as required for implementing the functionality described in this disclosure. General functional details about the platform 110 and the user devices 120 are discussed below before particular functions for optimizing the sharing of media in a collaborative virtual environment are discussed.

As shown in FIG. 1A, the platform 110 includes different architectural features, including a content creator/manager 111, a collaboration manager 115, and an input/output (I/O) interface 119. The content creator/manager 111 creates and stores visual representations of things as virtual content that can be displayed by a user device 120 to appear within a virtual or physical environment. Examples of virtual content include: virtual objects, virtual environments, avatars, video, images, text, audio, or other presentable data. The collaboration manager 115 provides virtual content to different user devices 120, and tracks poses (e.g., positions and orientations) of virtual content and of user devices as is known in the art (e.g., in mappings of environments, or other approaches). The I/O interface 119 sends or receives data between the platform 110 and each of the user devices 120.

Each of the user devices 120 include different architectural features, and may include the features shown in FIG. 1B, including a local storage component 122, sensors 124, processor(s) 126, an input/output (I/O) interface 128, and a display 129. The local storage component 122 stores content received from the platform 110 through the I/O interface 128, as well as information collected by the sensors 124. The sensors 124 may include: inertial sensors that track movement and orientation (e.g., gyros, accelerometers and others known in the art); optical sensors used to track movement and orientation of user gestures; position-location or proximity sensors that track position in a physical environment (e.g., GNSS, WiFi, Bluetooth or NFC chips, or others known in the art); depth sensors; cameras or other image sensors that capture images of the physical environment or user gestures; audio sensors that capture sound (e.g., microphones); and/or other known sensor(s). It is noted that the sensors described herein are for illustration purposes only and the sensors 124 are thus not limited to the ones described. The processor 126 runs different applications needed to display any virtual content within a virtual or physical environment that is in view of a user operating the user device 120, including applications for: rendering virtual content; tracking the pose (e.g., position and orientation) and the field of view of the user device 120 (e.g., in a mapping of the environment if applicable to the user device 120) so as to determine what virtual content is to be rendered on a display (not shown) of the user device 120; capturing images of the environment using image sensors of the user device 120 (if applicable to the user device 120); and other functions. The I/O interface 128 manages transmissions of data between the user device 120 and the platform 110. The display 129 may include, for example, a touchscreen display configured to receive user input via a contact on the touchscreen display, a semi or fully transparent display, or a non-transparent display. In one example, the display 129 includes a screen or monitor configured to display images generated by the processor 126. In another example, the display 129 may be transparent or semi-opaque so that the user can see through the display 129.

Particular applications of the processor 126 may include: a communication application, a display application, and a gesture application. The communication application may be configured to communicate data from the user device 120 to the platform 110 or to receive data from the platform 110, may include modules that may be configured to send images and/or videos captured by a camera of the user device 120 from sensors 124, and may include modules that determine the geographic location and the orientation of the user device 120 (e.g., determined using GNSS, WiFi, Bluetooth, audio tone, light reading, an internal compass, an accelerometer, or other approaches). The display application may generate virtual content in the display 129, which may include a local rendering engine that generates a visualization of the virtual content. The gesture application identifies gestures made by the user (e.g., predefined motions of the user's arms or fingers, or predefined motions of the user device 120 (e.g., tilt, movements in particular directions, or others). Such gestures may be used to define interaction or manipulation of virtual content (e.g., moving, rotating, or changing the orientation of virtual content).

Examples of the user devices 120 include VR, AR, MR and general computing devices with displays, including: head-mounted displays; sensor-packed wearable devices with a display (e.g., glasses); mobile phones; tablets; or other computing devices that are suitable for carrying out the functionality described in this disclosure. Depending on implementation, the components shown in the user devices 120 can be distributed across different devices (e.g., a worn or held peripheral separate from a processor running a client application that is communicatively coupled to the peripheral).

Having discussed features of systems on which different embodiments may be implemented, attention is now drawn to different processes for optimizing the sharing of media in a collaborative virtual environment.

### Optimizing the Sharing of Media in a Collaborative Virtual Environment

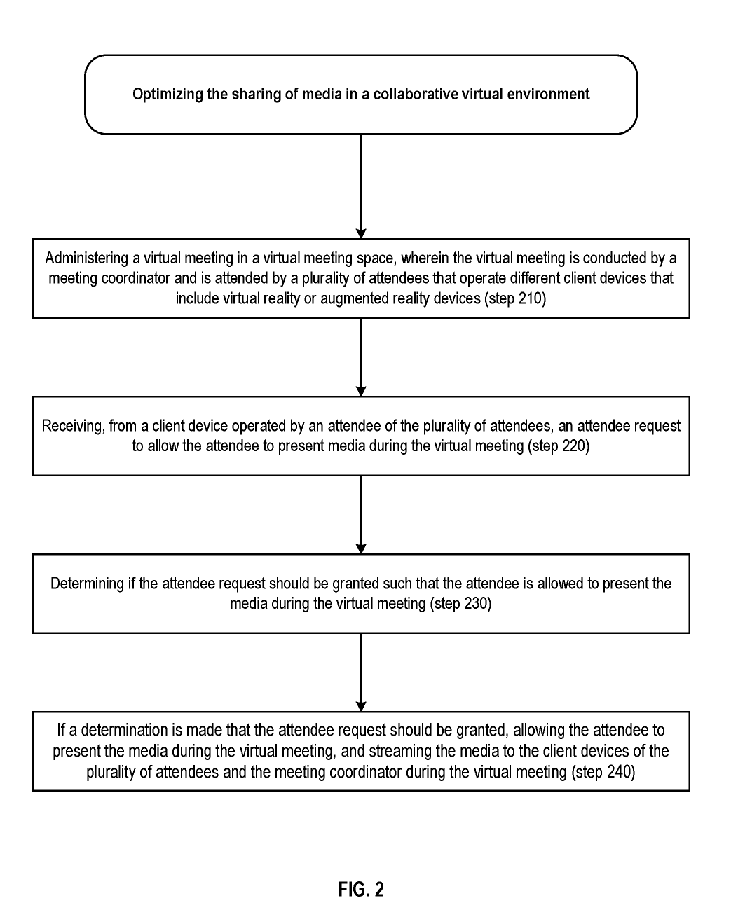

FIG. 2 depicts a method for optimizing the sharing of media in a collaborative virtual environment. As shown, a virtual meeting in a virtual meeting space is administered (e.g., using one or more suitable machines), wherein the virtual meeting is conducted by a meeting coordinator and is attended by a plurality of attendees that operate different client devices, such as virtual reality or augmented reality devices (step 210). An attendee request to allow an attendee of the plurality of attendees to present media during the virtual meeting is receive from a client device operated by the attendee (step 220). A determination is made as to whether the attendee request should be granted such that the attendee is allowed to present the media during the virtual meeting (step 230). If a determination is made that the attendee request should be granted, the attendee is allowed to present the media during the virtual meeting, and the media presented by the attendee is streamed to the client devices of the plurality of attendees and the meeting coordinator during the virtual meeting (step 240). Examples of media include audio, video or other types of media generated by the client device of the attendee.

By way of example, the virtual meeting may be administered using a virtual environment the attendees virtually join and view using their client devices (e.g., head-mounted displays, smart phones, computers, or other devices). Administering of the virtual meeting may include providing presented media to attendees, controlling whether an attendee can present media based on automated rules or indications from the meeting coordinator, and any known processes needed to conduct a virtual meeting.

In one embodiment of the method shown in FIG. 2, if a determination is made that the attendee request should not be granted, the attendee is not allowed to present the media to other attendees.

In one embodiment of the method shown in FIG. 2, the attendee request is generated when a gesture by the attendee is recognized. Recognition may be by the client device or the collaboration manager using known techniques for recognizing gestures.

In one embodiment of the method shown in FIG. 2, determining if the attendee request should be granted such that the attendee is allowed to present the media during the virtual meeting comprises: determining if automated floor control rules specify that the attendee request should be granted, denied or queued. By way of example, automated floor control rules may specify that the attendee request should be granted, denied or queued based on: existence of a conflict; a privilege of the attendee; a history of requests, presented media or content from the attendee; a type of engagement; time constraints of the virtual meeting; or if the request is similar to one or more other requests from the attendee or one or more other attendees. By way of example, a conflict may include whether other media is being provided by another attendee or the meeting coordinator. By way of example, a type of engagement may include a designation of the type of virtual meeting (e.g., a training session where attendee presentation is limited or not allowed). By way of example, a similar request may be a request to present the same media. By way of example, a history of requests, presented media or content from the attendee include inappropriate or undesirable content previously shared by the attendee.

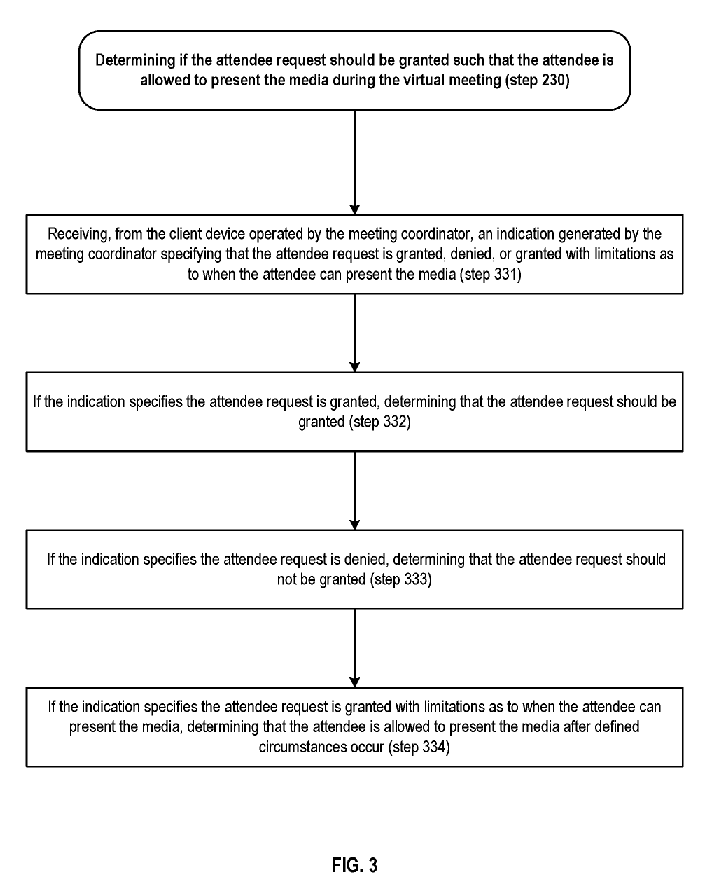

In one embodiment of the method shown in FIG. 2, the attendee request is provided to the meeting coordinator for review, and step 230 for determining if the attendee request should be granted such that the attendee is allowed to present the media during the virtual meeting comprises the steps shown in FIG. 3, which include: receiving, from the client device operated by the meeting coordinator, an indication generated by the meeting coordinator specifying that the attendee request is granted, denied, or granted with limitations as to when the attendee can present the media (step 331); if the indication specifies the attendee request is granted, determining that the attendee request should be granted (step 332)—i.e., the attendee is allowed to present the media; if the indication specifies the attendee request is denied, determining that the attendee request should not be granted (step 333)—i.e., the attendee is not allowed to present the media; and if the indication specifies the attendee request is granted with limitations as to when the attendee can present the media, determining that the attendee is allowed to present the media after defined circumstances occur (step 334). In one embodiment of FIG. 3, the defined circumstances include: presentation of other media concluding during the virtual meeting.

In one embodiment of the method shown in FIG. 2, the attendee request is provided to the meeting coordinator for review, and determining if the attendee request should be granted such that the attendee is allowed to present the media during the virtual meeting comprises: receiving, from the client device operated by the meeting coordinator, an indication generated by the meeting coordinator specifying that the attendee request is granted; and determining that the attendee request should be granted based on the indication specifying the attendee request is granted. By way of example, the indications generated by the meeting coordinator may be an option selected by the meeting coordinator through an application running on the client device operated by the meeting coordinator.

In one embodiment of the method shown in FIG. 2, the attendee request is provided to the meeting coordinator for review, and determining if the attendee request should be granted such that the attendee is allowed to present the media during the virtual meeting comprises: receiving, from the client device operated by the meeting coordinator, an indication generated by the meeting coordinator specifying that the attendee request is denied; determining that the attendee request should be not be granted based on the indication specifying the attendee request is denied; sending a message to the attendee indicating that the attendee request is not granted; and receiving, at a later time from the client device operated by the attendee, another attendee request to allow the attendee to present the media during the virtual meeting, at which point processing of the other attendee request occurs using methods disclosed herein.

In one embodiment of the method shown in FIG. 2, the attendee request is provided to the meeting coordinator for review, and determining if the attendee request should be granted such that the attendee is allowed to present the media during the virtual meeting comprises: receiving, from the client device operated by the meeting coordinator, an indication generated by the meeting coordinator specifying that the attendee request is granted or denied; if the indication specifies the attendee request is granted, determining that the attendee request should be granted; and if the indication specifies the attendee request is denied, determining that the attendee request should not be granted and sending a message to the attendee indicating that the attendee request is not granted.

In one embodiment of the method shown in FIG. 2, determining if the attendee request should be granted such that the attendee is allowed to present the media during the virtual meeting comprises: receiving, from the client device operated by the meeting coordinator, an indication generated by the meeting coordinator specifying that the attendee can present the media only after defined circumstances occur. In one embodiment, the defined circumstances include: presentation of other media concluding during the virtual meeting.

In one embodiment of the method shown in FIG. 2, conditions of the virtual meeting specify that no more than one attendee can present media at a time during the virtual meeting.

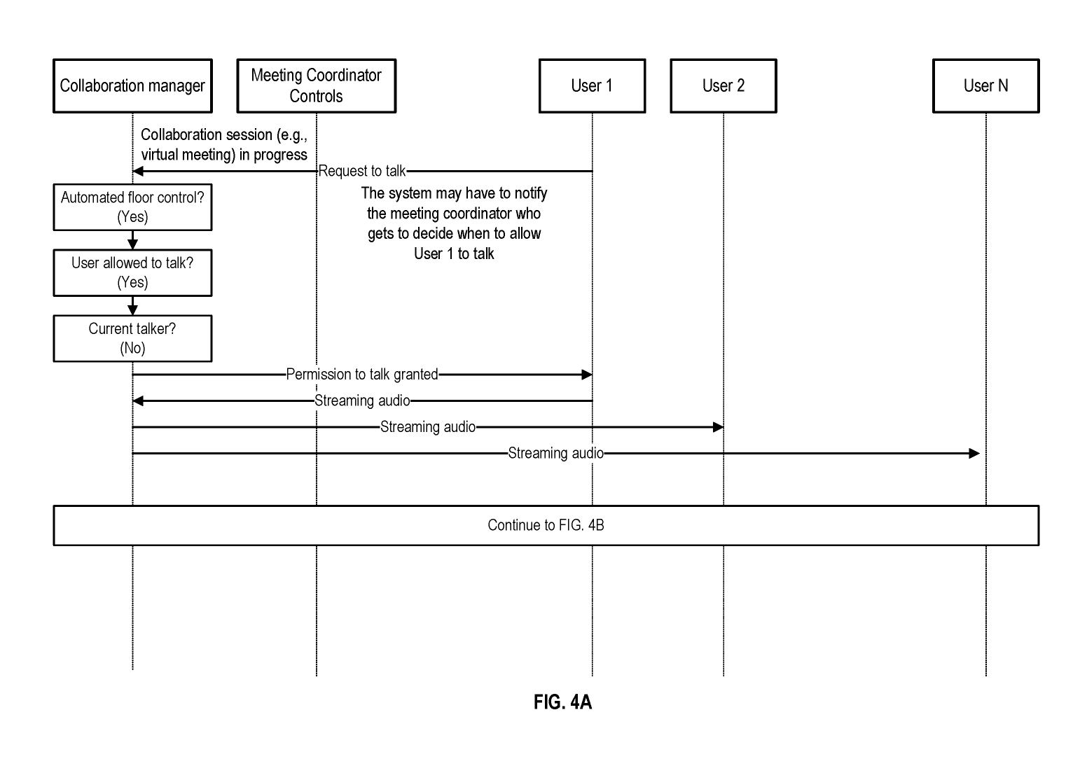

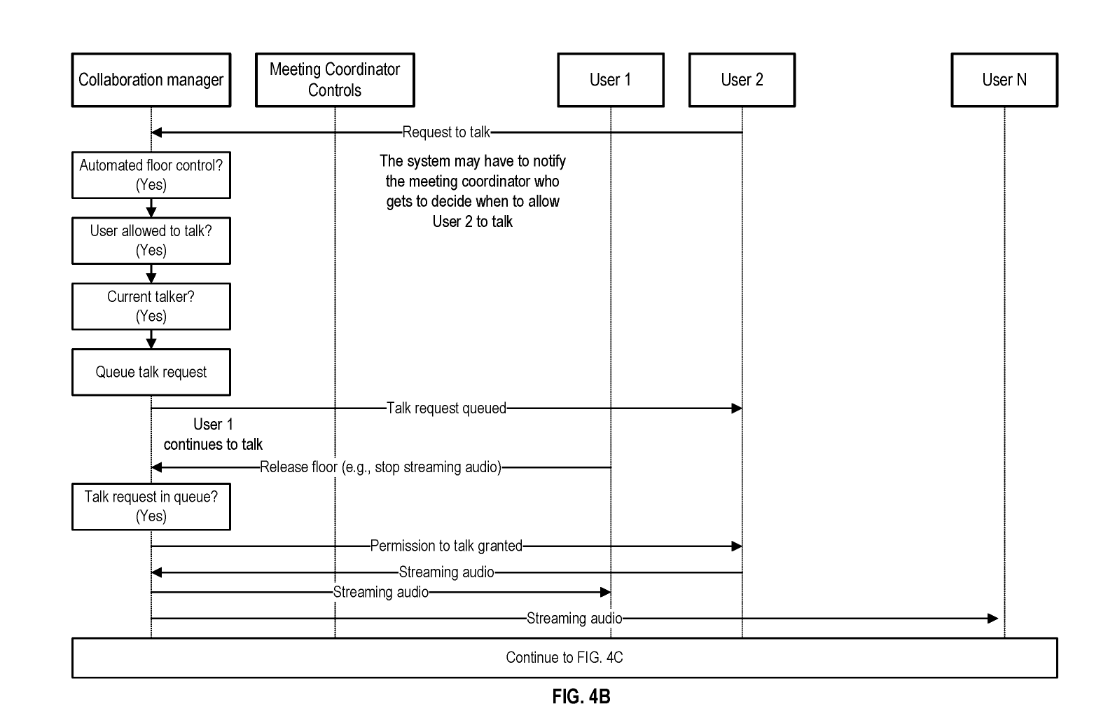

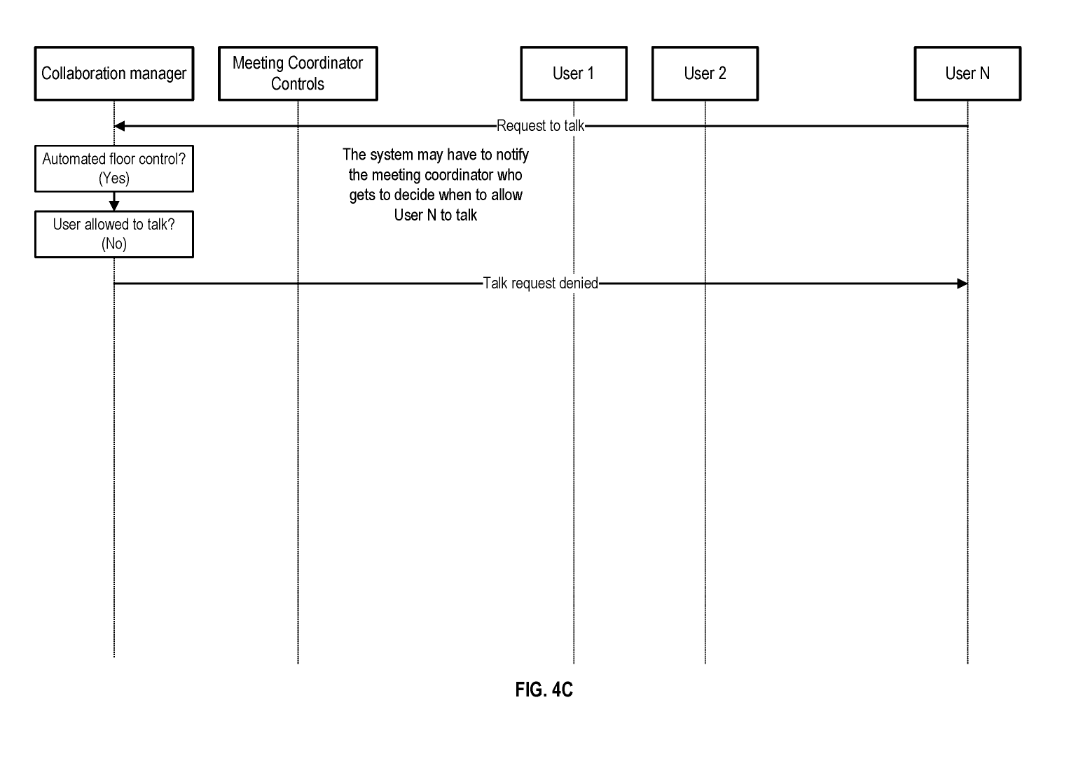

FIG. 4A through FIG. 4C provide a communication sequence diagram for a system that automatically controls whether different attendees can present media.

As shown in FIG. 4A, while a collaboration session (e.g., a virtual meeting) is in progress, a first user sends a request to talk, which is received by a collaboration manager (e.g., a server). The collaboration manager determines it can automatically decide whether the first user can talk—e.g., “Automated floor control? (Yes)”, so the collaboration manager does not have to notify the meeting coordinator of the request from the first user and allow the meeting coordinator to decide when to allow the first user to talk. The collaboration manager determines that the first user is allowed to talk—e.g., “User allowed to talk? (Yes)”—which may be determined based on preset automatic rules described elsewhere herein. The collaboration manager then determines that there is no current talker—e.g., “Current talker? (No)”. Since there is no current talker and the first user is allowed to talk, the collaboration manager permits the first user to talk, after which the first user begins to generate streaming audio by talking, which is sent to the collaboration manager. The collaboration manager distributes the streaming audio to other users.

As shown in FIG. 4B, while the first user is streaming audio (e.g., talking), a second user sends a request to talk, which is received by the collaboration manager. The collaboration manager determines it can automatically decide whether the second user can talk—e.g., “Automated floor control? (Yes)”. The collaboration manager determines that the second user is allowed to talk—e.g., “User allowed to talk? (Yes)”. The collaboration manager then determines that the first user is still talking—e.g., “Current talker? (Yes)”. Since there is a current talker, and since the second user is allowed to talk, the collaboration manager queues the request and allows the second user to talk only after the first user stops talking (e.g., releases the floor or is forced to release the floor by the meeting coordinator). Once the first user stops streaming audio, the collaboration manager determines if a request to talk has been queued—e.g., “Talk request in queue? (Yes)”. The collaboration manager determines that the second user's request to talk is next in the queue, and then permits the second user to generate streaming audio that is shared with other users.

As shown in FIG. 4C, a third user sends a request to talk, which is received by the collaboration manager. The collaboration manager determines it can automatically decide whether the third user can talk—e.g., “Automated floor control? (Yes)”. The collaboration manager determines that the third user is not allowed to talk—e.g., “User allowed to talk? (No)”. The collaboration manager denies the request sent from the third user and does not permit the third user to generate streaming audio to share with other users.

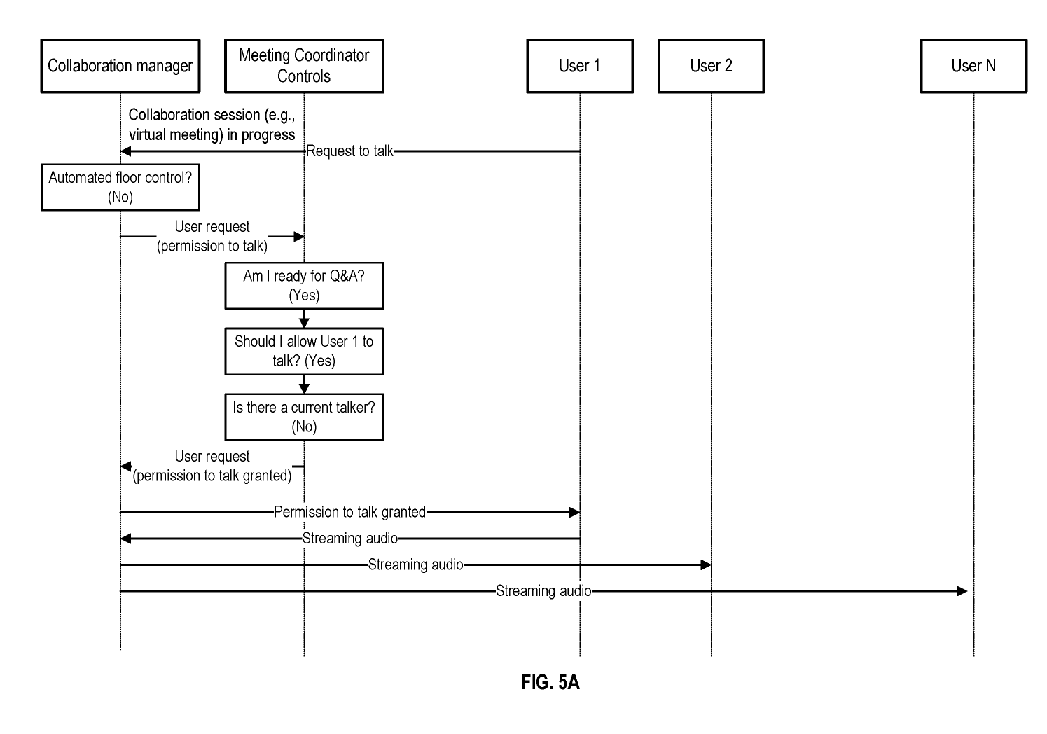

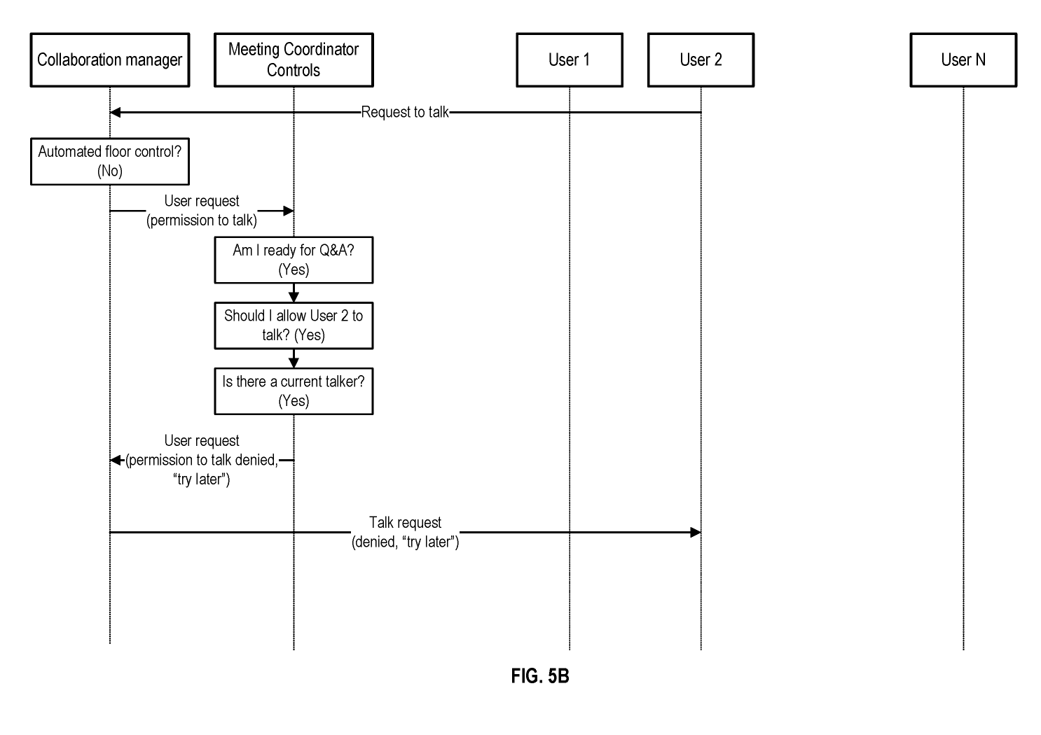

FIG. 5A through FIG. 5B provide a communication sequence diagram for a system that manually controls whether different attendees can present media using decisions from a meeting coordinator.

As shown in FIG. 5A, while a collaboration session (e.g., a virtual meeting) is in progress, a first user sends a request to talk, which is received by the collaboration manager. The collaboration manager determines it cannot automatically decide whether the first user can talk—e.g., “Automated floor control? (No)”, so the collaboration manager has to notify the meeting coordinator of the request from the first user to allow the meeting coordinator to decide whether to allow the first user to talk. The meeting coordinator determines he or she is ready for attendees to talk—e.g., “Am I ready for Q&A? (Yes)”—and determines he or she will allow the first user to talk—e.g., “Should I allow User 1 to talk? (Yes)”. Then, the meeting coordinator determines that no other attendee is talking—e.g., “Is there a current talker? (No)”, after which the meeting coordinator generates a message sent to the collaboration manager indicating that the meeting coordinator grants the first user permission to talk. Based on the message indicating that the meeting coordinator grants the first user permission to talk, the collaboration manager permits the first user to talk, after which the first user begins to generate streaming audio by talking, which is sent to the collaboration manager. The collaboration manager distributes the streaming audio to other users.

As shown in FIG. 5B, while the second user is streaming audio, a second user sends a request to talk, which is received by the collaboration manager. The collaboration manager determines it cannot automatically decide whether the second user can talk—e.g., “Automated floor control? (No)”, so the collaboration manager has to notify the meeting coordinator of the request from the second user to allow the meeting coordinator to decide whether to allow the second user to talk. The meeting coordinator determines he or she is ready for attendees to talk—e.g., “Am I ready for Q&A? (Yes)”—and determines he or she will allow the second user to talk—e.g., “Should I allow User 2 to talk? (Yes)”. Either the meeting coordinator or the collaboration manager then determines that the first user is still talking—e.g., “Current talker? (Yes)” after which the second user is denied permission to talk, but requested to submit another request later (e.g., via a message sent to the second user).

In AR, VR and MR environments, the collaboration sessions can involve participants from all over the globe and the participants in most cases are using a head-mounted display (HMD) or other device to allow them to participant and this necessarily limits their ability to observe and interpret body language and facial expressions of other participants. Since the element of sharing the same physical location and being hindered by a device to participate, aspects of this disclosure suggests using floor control mechanism to mimic the behavior usually exercised in collaborative meetings conducted in the same physical location or using video conferencing to capture/share the participants' activity.

One embodiment is a method for optimizing the sharing of audio, video and other media in a collaborative virtual, augmented or mixed reality environment. The method includes conducting a virtual meeting in a virtual meeting space, the virtual meeting conducted by a meeting coordinator and attended by a plurality of attendees, each of the plurality of attendees having a client device. The method also includes transmitting an attendee request from an attendee of the plurality of attendees to present at least one of audio, video or other media during the virtual meeting to a collaboration manager. The method also includes determining at the collaboration manager if the attendee request should be granted. The method also includes granting permission to the attendee to present at least one of audio, video or other media during the virtual meeting. The method also includes streaming at least one audio, video or other media to each of the plurality of attendees and the meeting coordinator during the virtual meeting.

Another embodiment is a system for optimizing the sharing of audio, video and other media in a collaborative virtual, augment or mixed reality environment. The system comprises a collaboration manager at a server, a meeting coordinator device, and a plurality of attendee devices. Each of the plurality of attendee devices comprises a processor, an IMU, and a display screen. The collaboration manager is configured to conduct a virtual meeting in a virtual meeting space, the virtual meeting conducted by a meeting coordinator and attended by a plurality of attendees. The collaboration manager is configured to receive an attendee request from an attendee of the plurality of attendees to present at least one of audio, video or other media during the virtual meeting. The collaboration manager is configured determine if the attendee request should be granted. The collaboration manager is configured to grant permission to the attendee to present at least one of audio, video or other media during the virtual meeting. The collaboration manager is configured to streaming at least one audio, video or other media for the attendee request to each of the plurality of attendees and the meeting coordinator during the virtual meeting.

Aspects of this disclosure use a floor control mechanism to mimic the behavior usually exercised in collaborative meetings conducted in the same physical location or using video conferencing to capture/share the participants' activity.

One significant benefit of aspects of this disclosure is that the complexity and resource usage is reduced by using floor control. Enforcing a floor control mechanism limits one contributor of media at a time. The contribution can be audio, video, or other streaming media. The limitation of one media stream input at a time eliminates the need for audio mixing and significantly reduces the bandwidth required for supporting streaming media.

As illustrated in the call flows provided, the floor control mechanism is implemented on a centralized server, i.e. the collaboration manager. The collaboration manager can be configured to automatically perform floor control or allow the meeting coordinator to apply floor control rules.

When a meeting participant desires to contribute, the meeting contributor selects an option or makes a gesture that is recognized by the HMD or the local processor to indicate a request for permission to contribute. The HMD or local processor sends a request to the collaboration manager which checks to see if the floor control is automated or requires human input. If the floor control is automated, the collaboration manager checks to see if the requestor has the authority or privilege to contribute. If the requestor has the privilege to contribute, the collaboration manager checks to see if there is already another contributor providing the same media type. If there is already a contributor providing the same media type, the collaboration manager checks to see if it is configured to queue requests to contribute. If the collaboration manager is not configured to queue requests, the collaboration manager would reject the request. If the collaboration manager can queue requests, the request is queued and the queued requests are serviced when the floor is released. If there is not a current contributor for the same media type, the collaboration manager can grant the floor to the requestor. The requestor sends the media and the collaboration manager copies and distributes the media to all the other participants.

The collaboration manager can also be configured to send permission to contribute requests to a meeting coordinator that would make the decisions on whether to grant permission. In addition, the meeting coordinator can make the decision on whether or not there is time for contributions during the meeting or if the participant should be allowed to contribute.

The permission to contribute can be based on whether there is a conflict (i.e. someone is already contributing that media type) or privilege of the requestor, history of requestor's content (e.g. inappropriate content contributor), or type of engagement (e.g. training session).

The media that can be contributed can be audio, video, or other streaming type media. The system may support one or more floor where each floor is associated with a specific media type. To avoid audio mixing, the system may require only one floor for media that contains audio, e.g. a video that contains audio cannot be contributed at the same time a person is speaking.

A first embodiment is a method for optimizing the sharing of audio, video and other media in a collaborative mixed reality environment. The method includes conducting a virtual meeting in a virtual meeting space, the virtual meeting conducted by a meeting coordinator and attended by a plurality of attendees, each of the plurality of attendees having a client device. The method also includes transmitting an attendee request from an attendee of the plurality of attendees to present at least one of audio, video or other media during the virtual meeting to a collaboration manager. The method also includes determining at the collaboration manager if the attendee request should be granted. The method also includes granting permission to the attendee to present at least one of audio, video or other media during the virtual meeting. The method also includes streaming at least one audio, video or other media to each of the plurality of attendees and the meeting coordinator during the virtual meeting.

A second embodiment is a method for optimizing the sharing of audio, video and other media in a collaborative virtual reality environment. The method includes conducting a virtual meeting in a virtual meeting space, the virtual meeting conducted by a meeting coordinator and attended by a plurality of attendees, each of the plurality of attendees having a client device. The method also includes transmitting an attendee request from an attendee of the plurality of attendees to present at least one of audio, video or other media during the virtual meeting to a collaboration manager. The method also includes determining at the collaboration manager if the attendee request should be granted. The method also includes granting permission to the attendee to present at least one of audio, video or other media during the virtual meeting. The method also includes streaming at least one audio, video or other media to each of the plurality of attendees and the meeting coordinator during the virtual meeting.

A third embodiment is a method for optimizing the sharing of audio, video and other media in a collaborative augmented reality environment. The method includes conducting a virtual meeting in a virtual meeting space, the virtual meeting conducted by a meeting coordinator and attended by a plurality of attendees, each of the plurality of attendees having a client device. The method also includes transmitting an attendee request from an attendee of the plurality of attendees to present at least one of audio, video or other media during the virtual meeting to a collaboration manager. The method also includes determining at the collaboration manager if the attendee request should be granted. The method also includes granting permission to the attendee to present at least one of audio, video or other media during the virtual meeting. The method also includes streaming at least one audio, video or other media to each of the plurality of attendees and the meeting coordinator during the virtual meeting.

A fourth embodiment is a system for optimizing the sharing of audio, video and other media in a collaborative mixed reality environment. The system comprises a collaboration manager at a server, a meeting coordinator device, and a plurality of attendee devices. Each of the plurality of attendee devices comprises a processor, an IMU, and a display screen. The collaboration manager is configured to conduct a virtual meeting in a virtual meeting space, the virtual meeting conducted by a meeting coordinator and attended by a plurality of attendees. The collaboration manager is configured to receive an attendee request from an attendee of the plurality of attendees to present at least one of audio, video or other media during the virtual meeting. The collaboration manager is configured determine if the attendee request should be granted. The collaboration manager is configured to grant permission to the attendee to present at least one of audio, video or other media during the virtual meeting. The collaboration manager is configured to streaming at least one audio, video or other media for the attendee request to each of the plurality of attendees and the meeting coordinator during the virtual meeting.

A fifth embodiment is a system for optimizing the sharing of audio, video and other media in a collaborative virtual reality environment. The system comprises a collaboration manager at a server, a meeting coordinator device, and a plurality of attendee devices. Each of the plurality of attendee devices comprises a processor, an IMU, and a display screen. The collaboration manager is configured to conduct a virtual meeting in a virtual meeting space, the virtual meeting conducted by a meeting coordinator and attended by a plurality of attendees. The collaboration manager is configured to receive an attendee request from an attendee of the plurality of attendees to present at least one of audio, video or other media during the virtual meeting. The collaboration manager is configured determine if the attendee request should be granted. The collaboration manager is configured to grant permission to the attendee to present at least one of audio, video or other media during the virtual meeting. The collaboration manager is configured to streaming at least one audio, video or other media for the attendee request to each of the plurality of attendees and the meeting coordinator during the virtual meeting.

A sixth embodiment is a system for optimizing the sharing of audio, video and other media in a collaborative augmented reality environment. The system comprises a collaboration manager at a server, a meeting coordinator device, and a plurality of attendee devices. Each of the plurality of attendee devices comprises a processor, an IMU, and a display screen. The collaboration manager is configured to conduct a virtual meeting in a virtual meeting space, the virtual meeting conducted by a meeting coordinator and attended by a plurality of attendees. The collaboration manager is configured to receive an attendee request from an attendee of the plurality of attendees to present at least one of audio, video or other media during the virtual meeting. The collaboration manager is configured determine if the attendee request should be granted. The collaboration manager is configured to grant permission to the attendee to present at least one of audio, video or other media during the virtual meeting. The collaboration manager is configured to streaming at least one audio, video or other media for the attendee request to each of the plurality of attendees and the meeting coordinator during the virtual meeting.

In one embodiment, the collaboration manager is configured use automated floor control rules to determine if the attendee request should be granted, denied, or queued.

In one embodiment, the automated floor control rules comprise determining if there is a conflict, determining a privilege of the requesting attendee, determining a history of the requests from the requesting attendee, determining a type of engagement, determining the time constraints of the virtual meeting and determining if the request is similar to other requests.

In one embodiment, the collaboration manager is configured to transmit the attendee request to the meeting coordinator and receive permission from the meeting coordinator to determine if the attendee request should be granted.

In one embodiment, the collaboration manager is configured to transmit the attendee request to the meeting coordinator, receive a denial from the meeting coordinator at the collaboration manager, and receive the attendee request at a later time during the virtual meeting to determine if the attendee request should be granted.

In one embodiment, the collaboration manager is configured to transmit the attendee request to the meeting coordinator and receive instructions from the meeting coordinator at the collaboration manager to queue the attendee request for a later time during the virtual meeting.

In one embodiment, the virtual meeting only allows one presenter at a time to present during the virtual meeting, wherein the presenter is one of the meeting coordinator or an attendee of the plurality of attendees to determine if the attendee request should be granted.

A virtual environment may include virtual assets that preferably comprise a whiteboard, a conference table, a plurality of chairs, a projection screen, a model of a jet engine, an model of an airplane, a model of an airplane hanger, a model of a rocket, a model of a helicopter, a model of a customer product, a tool used to edit or change a virtual asset in real time, a plurality of adhesive notes, a projection screen, a drawing board, a 3-D replica of at least one real world object, a 3-D visualization of customer data, a virtual conference phone, a computer, a computer display, a replica of the user's cell phone, a replica of a laptop, a replica of a computer, a 2-D photo viewer, a 3-D photo viewer, 2 2-D image viewer, a 3-D image viewer, a 2-D video viewer, a 3-D video viewer, a 2-D file viewer, a 3-D scanned image of a person, 3-D scanned image of a real world object, a 2-D map, a 3-D map, a 2-D cityscape, a 3-D cityscape, a 2-D landscape, a 3-D landscape, a replica of a real world, physical space, or at least one avatar.

A HMD of at least one attendee of the plurality of attendees is structured to hold a client device comprising a processor, a camera, a memory, a software application residing in the memory, an IMU, and a display screen.

The client device of each of the plurality of attendees may comprise at least one of a personal computer, HMD, a laptop computer, a tablet computer or a mobile computing device. An HMD may be structured to hold a client device comprising a processor, a camera, a memory, a software application residing in the memory, an IMU, and a display screen.

A display device is preferably selected from the group comprising a desktop computer, a laptop computer, a tablet computer, a mobile phone, an AR headset, and a VR headset.

User interface elements include the capacity viewer and mode changer.

The human eye's performance. 150 pixels per degree (foveal vision). Field of view Horizontal: 145 degrees per eye Vertical 135 degrees. Processing rate: 150 frames per second Stereoscopic vision Color depth: 10 million? (Let's decide on 32 bits per pixel)=470 megapixels per eye, assuming full resolution across entire FOV (33 megapixels for practical focus areas) Human vision, full sphere: 50 Gbits/sec. Typical HD video: 4 Mbits/sec and we would need >10,000 times the bandwidth. HDMI can go to 10 Mbps.

For each selected environment there are configuration parameters associated with the environment that the author must select, for example, number of virtual or physical screens, size/resolution of each screen, and layout of the screens (e.g. carousel, matrix, horizontally spaced, etc). If the author is not aware of the setup of the physical space, the author can defer this configuration until the actual meeting occurs and use the Narrator Controls to set up the meeting and content in real-time.

The following is related to a VR meeting. Once the environment has been identified, the author selects the AR/VR assets that are to be displayed. For each AR/VR asset the author defines the order in which the assets are displayed. The assets can be displayed simultaneously or serially in a timed sequence. The author uses the AR/VR assets and the display timeline to tell a “story” about the product. In addition to the timing in which AR/VR assets are displayed, the author can also utilize techniques to draw the audience's attention to a portion of the presentation. For example, the author may decide to make an AR/VR asset in the story enlarge and/or be spotlighted when the “story” is describing the asset and then move to the background and/or darken when the topic has moved on to another asset.

When the author has finished building the story, the author can play a preview of the story. The preview playout of the story as the author has defined but the resolution and quality of the AR/VR assets are reduced to eliminate the need for the author to view the preview using AR/VR headsets. It is assumed that the author is accessing the story builder via a web interface, so therefore the preview quality should be targeted at the standards for common web browsers.

After the meeting organizer has provided all the necessary information for the meeting, the Collaboration Manager sends out an email to each invitee. The email is an invite to participate in the meeting and also includes information on how to download any drivers needed for the meeting (if applicable). The email may also include a preload of the meeting material so that the participant is prepared to join the meeting as soon as the meeting starts.

The Collaboration Manager also sends out reminders prior to the meeting when configured to do so. Both the meeting organizer or the meeting invitee can request meeting reminders. A meeting reminder is an email that includes the meeting details as well as links to any drivers needed for participation in the meeting.

Prior to the meeting start, the user needs to select the display device the user will use to participate in the meeting. The user can use the links in the meeting invitation to download any necessary drivers and preloaded data to the display device. The preloaded data is used to ensure there is little to no delay experienced at meeting start. The preloaded data may be the initial meeting environment without any of the organization's AR/VR assets included. The user can view the preloaded data in the display device, but may not alter or copy it.

At meeting start time each meeting participant can use a link provided in the meeting invite or reminder to join the meeting. Within 1 minute after the user clicks the link to join the meeting, the user should start seeing the meeting content (including the virtual environment) in the display device of the user's choice. This assumes the user has previously downloaded any required drivers and preloaded data referenced in the meeting invitation.

Each time a meeting participant joins the meeting, the story Narrator (i.e. person giving the presentation) gets a notification that a meeting participant has joined. The notification includes information about the display device the meeting participant is using. The story Narrator can use the Story Narrator Control tool to view each meeting participant's display device and control the content on the device. The Story Narrator Control tool allows the Story Narrator to.

View all active (registered) meeting participants

View all meeting participant's display devices

View the content the meeting participant is viewing

View metrics (e.g. dwell time) on the participant's viewing of the content

Change the content on the participant's device

Enable and disable the participant's ability to fast forward or rewind the content

Each meeting participant experiences the story previously prepared for the meeting. The story may include audio from the presenter of the sales material (aka meeting coordinator) and pauses for Q&A sessions. Each meeting participant is provided with a menu of controls for the meeting. The menu includes options for actions based on the privileges established by the Meeting Coordinator defined when the meeting was planned or the Story Narrator at any time during the meeting. If the meeting participant is allowed to ask questions, the menu includes an option to request permission to speak. If the meeting participant is allowed to pause/resume the story, the menu includes an option to request to pause the story and once paused, the resume option appears. If the meeting participant is allowed to inject content into the meeting, the menu includes an option to request to inject content.

The meeting participant can also be allowed to fast forward and rewind content on the participant's own display device. This privilege is granted (and can be revoked) by the Story Narrator during the meeting.

After an AR story has been created, a member of the maintenance organization that is responsible for the “tools” used by the service technicians can use the Collaboration Manager Front-End to prepare the AR glasses to play the story. The member responsible for preparing the tools is referred to as the tools coordinator.

In the AR experience scenario, the tools coordinator does not need to establish a meeting and identify attendees using the Collaboration Manager Front-End, but does need to use the other features provided by the Collaboration Manager Front-End. The tools coordinator needs a link to any drivers necessary to playout the story and needs to download the story to each of the AR devices. The tools coordinator also needs to establish a relationship between the Collaboration Manager and the AR devices. The relationship is used to communicate any requests for additional information (e.g. from external sources) and/or assistance from a call center. Therefore, to the Collaboration Manager Front-End the tools coordinator is essentially establishing an ongoing, never ending meeting for all the AR devices used by the service team.

Ideally Tsunami would build a function in the VR headset device driver to “scan” the live data feeds for any alarms and other indications of a fault. When an alarm or fault is found, the driver software would change the data feed presentation in order to alert the support team member that is monitoring the virtual NOC.

The support team member also needs to establish a relationship between the Collaboration Manager and the VR headsets. The relationship is used to connect the live data feeds that are to be displayed on the Virtual NOCC to the VR headsets. communicate any requests for additional information (e.g. from external sources) and/or assistance from a call center. Therefore, to the Collaboration Manager Front-End the tools coordinator is essentially establishing an ongoing, never ending meeting for all the AR devices used by the service team.

The story and its associated access rights are stored under the author's account in Content Management System. The Content Management System is tasked with protecting the story from unauthorized access. In the virtual NOCC scenario, the support team member does not need to establish a meeting and identify attendees using the Collaboration Manager Front-End, but does need to use the other features provided by the Collaboration Manager Front-End. The support team member needs a link to any drivers necessary to playout the story and needs to download the story to each of the VR head.

The Asset Generator is a set of tools that allows a Tsunami artist to take raw data as input and create a visual representation of the data that can be displayed in a VR or AR environment. The raw data can be virtually any type of input from: 3D drawings to CAD files, 2D images to power point files, user analytics to real time stock quotes. The Artist decides if all or portions of the data should be used and how the data should be represented. The i Artist is empowered by the tool set offered in the Asset Generator.

The Content Manager is responsible for the storage and protection of the Assets. The Assets are VR and AR objects created by the Artists using the Asset Generator as well as stories created by users of the Story Builder.

Asset Generation Sub-System: Inputs: from anywhere it can: Word, Powerpoint, Videos, 3D objects etc. and turns them into interactive objects that can be displayed in AR/VR (HMD or flat screens). Outputs: based on scale, resolution, device attributes and connectivity requirements.

Story Builder Subsystem: Inputs: Environment for creating the story. Target environment can be physical and virtual. Assets to be used in story; Library content and external content (Word, Powerpoint, Videos, 3D objects etc). Output: Story; =Assets inside an environment displayed over a timeline. User Experience element for creation and editing.

CMS Database: Inputs: Manages The Library, Any asset: AR/VR Assets, MS Office files and other 2D files and Videos. Outputs: Assets filtered by license information.

Collaboration Manager Subsystem. Inputs: Stories from the Story Builder, Time/Place (Physical or virtual)/Participant information (contact information, authentication information, local vs. Geographically distributed). During the gathering/meeting gather and redistribute: Participant real time behavior, vector data, and shared real time media, analytics and session recording, and external content (Word, Powerpoint, Videos, 3D objects etc). Output: Story content, allowed participant contributions Included shared files, vector data and real time media; and gathering rules to the participants. Gathering invitation and reminders. Participant story distribution. Analytics and session recording (Where does it go). (Out-of-band access/security criteria).

Device Optimization Service Layer. Inputs: Story content and rules associated with the participant. Outputs: Analytics and session recording. Allowed participant contributions.

Rendering Engine Obfuscation Layer. Inputs: Story content to the participants. Participant real time behavior and movement. Outputs: Frames to the device display. Avatar manipulation

Real-time platform: The RTP This cross-platform engine is written in C++ with selectable DirectX and OpenGL renderers. Currently supported platforms are Windows (PC), iOS (iPhone/iPad), and Mac OS X. On current generation PC hardware, the engine is capable of rendering textured and lit scenes containing approximately 20 million polygons in real time at 30 FPS or higher. 3D wireframe geometry, materials, and lights can be exported from 3DS MAX and Lightwave 3D modeling/animation packages. Textures and 2D UI layouts are imported directly from Photoshop PSD files. Engine features include vertex and pixel shader effects, particle effects for explosions and smoke, cast shadows blended skeletal character animations with weighted skin deformation, collision detection, Lua scripting language of all entities, objects and properties.

### Other Aspects

Each method of this disclosure can be used with virtual reality (VR), augmented reality (AR), and/or mixed reality (MR) technologies. Virtual environments and virtual content may be presented using VR technologies, AR technologies, and/or MR technologies. By way of example, a virtual environment in AR may include one or more digital layers that are superimposed onto a physical (real world environment).

The user of a user device may be a human user, a machine user (e.g., a computer configured by a software program to interact with the user device), or any suitable combination thereof (e.g., a human assisted by a machine, or a machine supervised by a human)

Methods of this disclosure may be implemented by hardware, firmware or software. One or more non-transitory machine-readable media embodying program instructions that, when executed by one or more machines, cause the one or more machines to perform or implement operations comprising the steps of any of the methods or operations described herein are contemplated. As used herein, machine-readable media includes all forms of machine-readable media (e.g. non-volatile or volatile storage media, removable or non-removable media, integrated circuit media, magnetic storage media, optical storage media, or any other storage media) that may be patented under the laws of the jurisdiction in which this application is filed, but does not include machine-readable media that cannot be patented under the laws of the jurisdiction in which this application is filed. By way of example, machines may include one or more computing device(s), processor(s), controller(s), integrated circuit(s), chip(s), system(s) on a chip, server(s), programmable logic device(s), other circuitry, and/or other suitable means described herein or otherwise known in the art. One or more machines that are configured to perform the methods or operations comprising the steps of any methods described herein are contemplated. Systems that include one or more machines and the one or more non-transitory machine-readable media embodying program instructions that, when executed by the one or more machines, cause the one or more machines to perform or implement operations comprising the steps of any methods described herein are also contemplated. Systems comprising one or more modules that perform, are operable to perform, or adapted to perform different method steps/stages disclosed herein are also contemplated, where the modules are implemented using one or more machines listed herein or other suitable hardware.

Method steps described herein may be order independent, and can therefore be performed in an order different from that described. It is also noted that different method steps described herein can be combined to form any number of methods, as would be understood by one of skill in the art. It is further noted that any two or more steps described herein may be performed at the same time. Any method step or feature disclosed herein may be expressly restricted from a claim for various reasons like achieving reduced manufacturing costs, lower power consumption, and increased processing efficiency. Method steps can be performed at any of the system components shown in the figures.

Processes described above and shown in the figures include steps that are performed at particular machines. In alternative embodiments, those steps may be performed by other machines (e.g., steps performed by a server may be performed by a user device if possible, and steps performed by the user device may be performed by the server if possible).

When two things (e.g., modules or other features) are “coupled to” each other, those two things may be directly connected together, or separated by one or more intervening things. Where no lines and intervening things connect two particular things, coupling of those things is contemplated in at least one embodiment unless otherwise stated. Where an output of one thing and an input of another thing are coupled to each other, information sent from the output is received by the input even if the data passes through one or more intermediate things. Different communication pathways and protocols may be used to transmit information disclosed herein. Information like data, instructions, commands, signals, bits, symbols, and chips and the like may be represented by voltages, currents, electromagnetic waves, magnetic fields or particles, or optical fields or particles.

The words comprise, comprising, include, including and the like are to be construed in an inclusive sense (i.e., not limited to) as opposed to an exclusive sense (i.e., consisting only of). Words using the singular or plural number also include the plural or singular number, respectively. The word or and the word and, as used in the Detailed Description, cover any of the items and all of the items in a list. The words some, any and at least one refer to one or more. The term may is used herein to indicate an example, not a requirement—e.g., a thing that may perform an operation or may have a characteristic need not perform that operation or have that characteristic in each embodiment, but that thing performs that operation or has that characteristic in at least one embodiment.

1. A method for optimizing the sharing of media in a collaborative virtual environment, the method comprising:
administering, using one or more machines, a virtual meeting in a virtual meeting space, wherein the virtual meeting is conducted by a meeting coordinator and is attended by a plurality of attendees that operate different client devices that include virtual reality or augmented reality devices;
receiving, from a client device operated by an attendee of the plurality of attendees, an attendee request to allow the attendee to present media during the virtual meeting;
determining if the attendee request should be granted such that the attendee is allowed to present the media during the virtual meeting; and
if a determination is made that the attendee request should be granted, allowing the attendee to present the media during the virtual meeting, and streaming the media to the client devices of the plurality of attendees and the meeting coordinator during the virtual meeting.

2. The method of claim 1, wherein the attendee request is generated when a gesture by the attendee is recognized.

3. The method of claim 1, wherein determining if the attendee request should be granted such that the attendee is allowed to present the media during the virtual meeting comprises:
determining if automated floor control rules specify that the attendee request should be granted, denied or queued.

4. The method of claim 3, wherein the automated floor control rules specify that the attendee request should be granted, denied or queued based on whether a conflict exists, a privilege of the attendee, a history of requests from the attendee, a type of engagement, time constraints of the virtual meeting, or if the request is similar to one or more other requests from the attendee or one or more other attendees.

5. The method of claim 1, wherein the attendee request is provided to the meeting coordinator for review, and wherein determining if the attendee request should be granted such that the attendee is allowed to present the media during the virtual meeting comprises:
receiving, from the client device operated by the meeting coordinator, an indication generated by the meeting coordinator specifying that the attendee request is granted; and
determining that the attendee request should be granted based on the indication specifying the attendee request is granted.

6. The method of claim 1, wherein the attendee request is provided to the meeting coordinator for review, and wherein determining if the attendee request should be granted such that the attendee is allowed to present the media during the virtual meeting comprises:
receiving, from the client device operated by the meeting coordinator, an indication generated by the meeting coordinator specifying that the attendee request is denied;
determining that the attendee request should be not be granted based on the indication specifying the attendee request is denied;
sending a message to the attendee indicating that the attendee request is not granted; and
receiving, at a later time from the client device operated by the attendee, another attendee request to allow the attendee to present the media during the virtual meeting.

7. The method of claim 1, wherein the attendee request is provided to the meeting coordinator for review, and wherein determining if the attendee request should be granted such that the attendee is allowed to present the media during the virtual meeting comprises:
receiving, from the client device operated by the meeting coordinator, an indication generated by the meeting coordinator specifying that the attendee request is granted or denied;
if the indication specifies the attendee request is granted, determining that the attendee request should be granted; and
if the indication specifies the attendee request is denied, determining that the attendee request should not be granted and sending a message to the attendee indicating that the attendee request is not granted.

8. The method of claim 1, wherein determining if the attendee request should be granted such that the attendee is allowed to present the media during the virtual meeting comprises:
receiving, from the client device operated by the meeting coordinator, an indication generated by the meeting coordinator specifying that the attendee can present the media only after defined circumstances occur.

9. The method of claim 8, wherein the defined circumstances include: presentation of other media concluding during the virtual meeting.

10. The method of claim 1, wherein the attendee request is provided to the meeting coordinator for review, and wherein determining if the attendee request should be granted such that the attendee is allowed to present the media during the virtual meeting comprises:
receiving, from the client device operated by the meeting coordinator, an indication generated by the meeting coordinator specifying that the attendee request is granted, denied, or granted with limitations as to when the attendee can present the media;
if the indication specifies the attendee request is granted, determining that the attendee request should be granted;
if the indication specifies the attendee request is denied, determining that the attendee request should not be granted; and
if the indication specifies the attendee request is granted with limitations as to when the attendee can present the media, determining that the attendee is allowed to present the media after defined circumstances occur.

11. The method of claim 10, wherein the defined circumstances include: presentation of other media concluding during the virtual.

12. The method of claim 1, wherein conditions of the virtual meeting specify that no more than one attendee can present media at a time during the virtual meeting.

13. One or more non-transitory machine-readable media embodying program instructions that, when executed by one or more machines, cause the one or more machines to implement the method of claim 1.
